(19) United States
(12) Patent Application Publication
(10) Pub. No.: US 2023/0368134 A1
(43) Pub. Date: Nov. 16, 2023

(54) INVENTORY MANAGEMENT SYSTEM, INVENTORY MANAGEMENT METHOD, AND INVENTORY MANAGEMENT PROGRAM

(71) Applicant: AUDER INC., Yokohama-shi, Kanagawa (JP)

(72) Inventor: Yuki KAGAMI, Tokyo (JP)

(21) Appl. No.: 18/247,833

(22) PCT Filed: Sep. 7, 2021
(86) PCT No.: PCT/JP2021/032792

§ 371 Date: Apr. 4, 2023

(30) Foreign Application Priority Data
Oct. 5, 2020 (JP) 2020-168739

(51) Int. Cl. G06Q 10/0875; G06Q 30/0601; G06K 7/10

(52) U.S. Cl. CPC G06Q 10/0875; G06K 7/10297; G06Q 30/0635

(57) ABSTRACT

An inventory of a product is managed on the basis of the remaining number of products specified by reading an electronic tag.

An inventory management system including: an electronic tag that stores tag information for specifying a product and is attached to the product; a measurement apparatus that is installed within a measurement range of the electronic tag and measures the tag information; and a server apparatus, in which the server apparatus includes: a registration means that stores a consumption unit set by a quantity of one or more of the products, and an appropriate inventory quantity set on the basis of the consumption unit in a storage unit as inventory management information regarding the product, an acquisition means that acquires a remaining number of the products specified by the tag information measured by the measurement apparatus, and an order placement means that refers to the inventory management information and outputs order placement data of the product when it is determined that the remaining number of the product is less than the appropriate inventory quantity.

### TECHNICAL FIELD

The present invention relates to an inventory management system, an inventory management method, and an inventory management program that order products on the basis of the remaining number of products specified by reading an electronic tag.

### BACKGROUND ART

Conventionally, a system used for inventory management of products or the like is known.

Patent Literature 1 discloses a general-purpose weight measuring means that can be used for inventory management and an inventory management system including the weight measuring means.

Patent Literature 2 discloses a refrigerator capable of appropriately managing a product in a storage compartment of the refrigerator. Patent Literature 2 discloses that the refrigerator includes a specifying means for specifying an arrangement position of a purchased product, a measuring means for measuring a remaining amount of a product contained in the storage compartment, and the like to acquire data of the purchased product, and, regarding an arbitrarily arranged product, places an order for the product when the remaining amount of the product is less than a minimum appropriate amount.

### CITATION LIST

### Patent Literature

Patent Literature 1: JP 6665234 A
Patent Literature 2: JP 2019-138493 A

### SUMMARY OF INVENTION

### Technical Problem

The inventory management system described in Patent Literature 1 is configured to use a weight measurement mat to measure the remaining amount by the weight of a product, and is used for inventory management. On the other hand, in the above-described inventory management system, it is necessary to store the positional relationship between the weight measurement mat and the product placed on the weight measurement mat in advance, and it is not possible to determine the type of the product. In addition, since the type of the product is not determined, for example, the inventory management of the product using additional information such as the expiration date for each product cannot be performed.

In addition, Patent Literature 2 discloses that the refrigerator described specifies a product by analyzing image data captured by a camera or reading an electronic tag attached to the product, and further measures a remaining amount of the product by weight and number with a weight sensor arranged in the storage compartment. On the other hand, providing a plurality of devices as described above has a problem that the cost increases. In addition, there is room for improvement from the viewpoint of simpler inventory management and order placement of products.

The present invention has been made in view of the above-described problems, and an object to be achieved is to provide an inventory management system, an inventory management method, and an inventory management program that order products on the basis of the remaining number of products specified by reading an electronic tag.

### Solution to Problem

In order to solve the above problems, the present invention is an inventory management system including: an electronic tag that stores tag information for specifying a product and is attached to the product; a measurement apparatus that is installed within a measurement range of the electronic tag and measures the tag information; and a server apparatus, in which the server apparatus includes: a registration means that stores a consumption unit set by a quantity of one or more of the products, and an appropriate inventory quantity set on the basis of the consumption unit in a storage unit as inventory management information regarding the product, an acquisition means that acquires a remaining number of the products specified by the tag information measured by the measurement apparatus, and an order placement means that refers to the inventory management information and outputs order placement data of the product when it is determined that the remaining number of the product is less than the appropriate inventory quantity.

With such a configuration, the remaining number of products can be appropriately measured according to the consumption unit of the product for each user, so that the inventory of the user can be accurately grasped only by measuring the electronic tag.

In a preferred mode of the present invention, the storage unit stores measurement apparatus identification information for identifying the measurement apparatus in association with user identification information for identifying a user, stores the tag information measured by the measurement apparatus having the measurement apparatus identification information in association with the measurement apparatus identification information, includes a product inventory table including information regarding the product specified by the tag information, and stores the inventory management information in association with each piece of information regarding the product included in the product inventory table, and the order placement means outputs order placement data of the product on the basis of the consumption unit included in the inventory management information and a difference between the appropriate inventory quantity and the remaining number of the product.

With such a configuration, the inventory management information registered in advance is associated with the product specified by the tag information measured by the measurement apparatus, so that efficient inventory management of the product can be performed. In addition, the order placement data of the product is output on the basis of the consumption unit included in the inventory management information and the difference between the appropriate inventory quantity and the remaining number of the product, so that the user can maintain the appropriate inventory quantity.

In a preferred mode of the present invention, the information regarding the product includes the consumption unit, and the registration means associates the appropriate inventory quantity with the information regarding the product, and stores the information in the storage unit as the inventory management information.

With such a configuration, since the consumption unit quantity is associated with the tag information in advance, the user can collectively order products including arbitrary products and quantities by selecting products on the basis of the tag information.

In a preferred mode of the present invention, the electronic tag is attached to a package including the quantity of products of the consumption unit.

With such a configuration, since the product is consumed for each package including the quantity of the consumption unit registered for each user, the remaining amount of the package can be grasped as the inventory quantity.

In a preferred mode of the present invention, the acquisition means stores time when the tag information measured by the measurement apparatus is acquired, and does not include the corresponding tag information in the remaining number of the product when a predetermined period has elapsed from the time.

With such a configuration, the electronic tag is invalidated when a predetermined period has elapsed after the measurement by the measurement apparatus, and it is possible to prevent the measurement apparatus from erroneously measuring the electronic tag attached to the consumed product as the inventory quantity.

In a preferred mode of the present invention, the electronic tag is attached to an opening portion of the package, and is broken or damaged when the opening portion is opened.

With such a configuration, since the electronic tag is physically invalidated at the time of consumption of the product (at the time of opening of the package), it is possible to prevent the measurement apparatus from erroneously measuring the electronic tag attached to the consumed product as the inventory quantity.

In a preferred mode of the present invention, the registration means stores, in the storage unit, information regarding the product specified by the tag information in association with expiration date information including a use-by date of the product, and the acquisition means does not include a product determined to have exceeded a predetermined time limit on the basis of the expiration date information as the remaining number of the product, and the order placement means outputs the order placement data with a difference between the appropriate inventory quantity of the product and a remaining amount of the product at a predetermined date and time as an order placement quantity.

With such a configuration, it is possible to output the order placement data so as to maintain an appropriate inventory quantity without including the expired product in the remaining number.

In a preferred mode of the present invention, in a case where the product is a foodstuff, the registration means stores the information regarding the product specified by the tag information in the storage unit in association with a best-time-to-eat period of the foodstuff, and an alert means that outputs an alert notifying that the foodstuff is best time to eat when the best-time-to-eat period is reached is provided.

With such a configuration, the user can receive the notification at the timing when the foodstuff is best time to eat.

In a preferred mode of the present invention, the acquisition means acquires health information indicating a health state of the user, and a proposal means that outputs recipe information of a dish at least including the foodstuff on the basis of the health information and the foodstuff included in the inventory management information is provided.

With such a configuration, the user can receive a proposal of a recipe for improving the health state using foodstuffs in stock.

In a preferred mode of the present invention, the proposal means outputs information regarding an insufficient foodstuff in at least one of a case where the remaining number of the foodstuff included in the inventory management information is smaller than a necessary number of foodstuffs included in the recipe information and a case where a foodstuff not registered in the inventory management information is included in the foodstuffs of the recipe information.

With such a configuration, in a case where the foodstuff of the recipe is insufficient, the user can receive the information regarding the insufficient foodstuff.

In a preferred mode of the present invention, the registration means further stores an order placement timing of the product specified by the tag information in the storage unit as the inventory management information, and the order placement means outputs the order placement data on the basis of the order placement timing.

With such a configuration, it is possible to set the order placement timing of the product for each product.

The present invention is an inventory management method for managing an inventory of a product, the method executing: by a measurement apparatus installed in a measurement range, a step of measuring tag information for specifying the product, the tag information being stored in an electronic tag attached to the product; by a server apparatus, a registration step of storing a consumption unit set by a quantity of one or more of the products, and an appropriate inventory quantity set on the basis of the consumption unit in a storage unit as inventory management information regarding the product; an acquisition step of acquiring a remaining number of the products specified by the tag information measured by the measurement apparatus; and an order placement step of referring to the inventory management information and outputting order placement data of the product when it is determined that the remaining number of the product is less than the appropriate inventory quantity.

The present invention is an inventory management program for managing an inventory of a product using: a measurement apparatus that is installed in a measurement range and measures tag information for specifying the product, the tag information being stored in an electronic tag attached to the product, the inventory management program causing a server apparatus to function as: a registration means that stores a consumption unit set by a quantity of one or more of the products, and an appropriate inventory quantity set on the basis of the consumption unit in a storage unit as inventory management information regarding the product, an acquisition means that acquires a remaining number of the products specified by the tag information measured by the measurement apparatus, and an order placement means that refers to the inventory management information and outputs order placement data of the product when it is determined that the remaining number of the product is less than the appropriate inventory quantity.

### Advantageous Effects of Invention

According to the present invention, it is possible to provide an inventory management system, an inventory management method, and an inventory management program that order products on the basis of the remaining number of products specified by reading an electronic tag.

### BRIEF DESCRIPTION OF DRAWINGS

FIG. 1 illustrates a functional block diagram of an inventory management system according to the present embodiment.

FIG. 2 illustrates a method of providing an electronic tag to a product according to the present embodiment.

FIG. 3 illustrates a hardware configuration diagram of an inventory management server according to the present embodiment.

FIG. 4 illustrates a hardware configuration diagram of a terminal apparatus according to the present embodiment.

FIG. 5 illustrates an example of a data structure of product information according to the present embodiment.

FIG. 6 illustrates an example of a data structure of inventory information according to the present embodiment.

FIG. 7 is a flowchart illustrating a flow of executing order placement processing according to the present embodiment.

### DESCRIPTION OF EMBODIMENTS

Hereinafter, an inventory management system related to an embodiment of the present invention will be described with reference to the drawings. Note that an embodiment described below is an example of the present invention, and the present invention is not limited to the embodiment described below, and various configurations can be adopted.

In the present embodiment, a configuration, an operation, and the like of an inventory management system including an electronic tag, a measurement apparatus, an inventory management server (server apparatus), and a user terminal will be described, but an inventory management program, an inventory management program recording medium, and the like having a similar configuration also have similar operations and effects. By using this program recording medium, for example, the program can be installed in a computer. A series of processing according to the present embodiment described below is provided as a computer-executable program, and can be provided via a non-transitory computer-readable recording medium such as a CD-ROM or a flexible disk, and further via a communication line.

Each means of the inventory management system and each step of the inventory management method achieve similar operations and effects. Each means of each of the inventory management system, the inventory management program, and the inventory management program recording medium is achieved by an arithmetic apparatus such as a CPU. In addition, each step of the inventory management method is also achieved by the arithmetic apparatus.

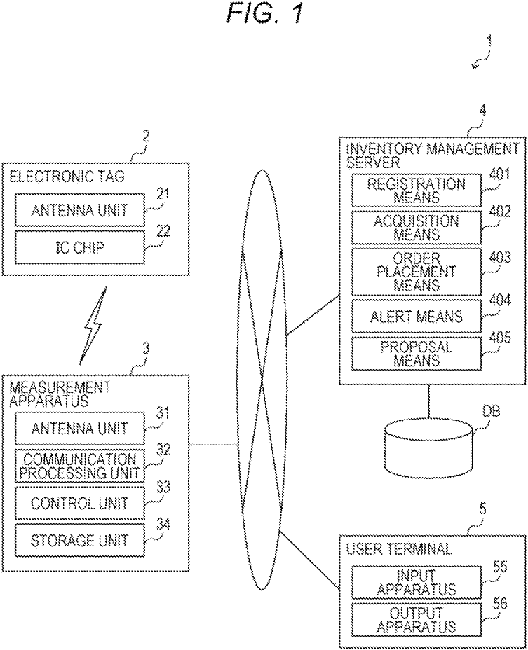

FIG. 1 illustrates a functional block diagram of an inventory management system 1 according to the present embodiment. The inventory management system 1 includes an electronic tag 2 that stores tag information for identifying a product and is attached to the product, a measurement apparatus 3 that is installed within a measurement range of the electronic tag and measures the tag information stored in the electronic tag, an inventory management server 4, and a user terminal 5 owned by a user. The measurement apparatus 3, the inventory management server 4, and the user terminal 5 are configured to be communicable via a communication network NW. The communication network NW includes an internet protocol (IP) network such as the Internet, a dedicated line, or the like. Note that, in the following description, the intervention of the communication network NW will be omitted unless otherwise unclear. Although only one electronic tag 2, one measurement apparatus 3, and one user terminal 5 are illustrated in FIG. 1, there are a plurality of electronic tags 2, a plurality of measurement apparatuses 3, and a plurality of user terminals 5.

The electronic tag 2 stores tag information for identifying a product, is attached to a product P, and is provided to the user. The electronic tag 2 includes at least an antenna unit 21 and an IC chip 22 as hardware components.

The measurement apparatus 3 is installed within a measurement range of the electronic tag 2, and measures the tag information stored in the electronic tag 2. The measurement apparatus 3 includes, as hardware components, an antenna unit 31, a communication processing unit 32, a control unit 33, a storage unit 34, and the like. The measurement apparatus 3 is installed around a measurement target space in which the product P, which is in stock, is stored. The measurement target space may be, for example, a closed space such as a cabinet, a pantry, or a storage compartment, or an open space such as a shelf or a desk. In addition, a plurality of the measurement apparatuses 3 may be installed by one user.

In the present embodiment, the electronic tag 2 attached to the product P and located in the measurement target space is a passive tag, and operates permanently using an electromagnetic wave emitted from the antenna unit 31 of the measurement apparatus 3 as an energy source, and does not need to incorporate a battery. The antenna unit 21 of the electronic tag 2 reflects a part of the electromagnetic wave from the antenna unit 31, and returns the tag information to the antenna unit 31 on the reflected wave. The communication processing unit 32 or the control unit 33 of the measurement apparatus 3 is configured to be capable of measuring the received signal intensity on the basis of the reflected wave received by the antenna unit 31.

As the frequency of the electromagnetic wave to which the passive tag corresponds, a HF band, a UHF band, a microwave band, and the like are generally known. In the present embodiment, the frequency band of the electromagnetic wave is not particularly limited, but is preferably the 920 MHz band of the UHF band. The reason is as described below. In use of the HF band radio wave, since the reading is performed by the electromagnetic induction coupling method, the magnetic field is inevitably blocked by the metal. In addition, in use of a radio wave in a microwave band (2.45 GHz), straightness of the radio wave is high, and thus there is a restriction that an article cannot be arranged to hide it behind the article.

Note that, in the present embodiment, the measurement apparatus 3 may be equipped with a temperature sensor, a humidity sensor, or the like, and may be configured to measure data (temperature, humidity, or the like) for managing the storage state of the product P. In addition, the measurement apparatus 3 may be equipped with a weight sensor, an imaging apparatus such as a camera, an optical scanner, or the like, and may be configured to measure data (quantity, remaining amount, size, position, or the like) for managing the inventory state of the product P. Note that, in the following description, “measurement” in the measurement apparatus 3 includes both of detecting the electronic tag/the tag information and measuring data for managing the storage state or the inventory state using the configuration such as the sensor or the like, and is simply referred to as “measurement” unless otherwise unclear.

The measurement apparatus 3 transmits information including the measured tag information to the inventory management server 4 in association with measurement apparatus identification information unique to the measurement apparatus.

The inventory management server 4 performs various processing for inventory management of the product P on the basis of the information received from the measurement apparatus 3. The inventory management server 4 includes a registration means 401, an acquisition means 402, an order placement means 403, an alert means 404, a proposal means 405, and a storage unit DB as functional components to be described in detail below. The storage unit DB stores various types of information, and is provided inside or outside the inventory management server 4.

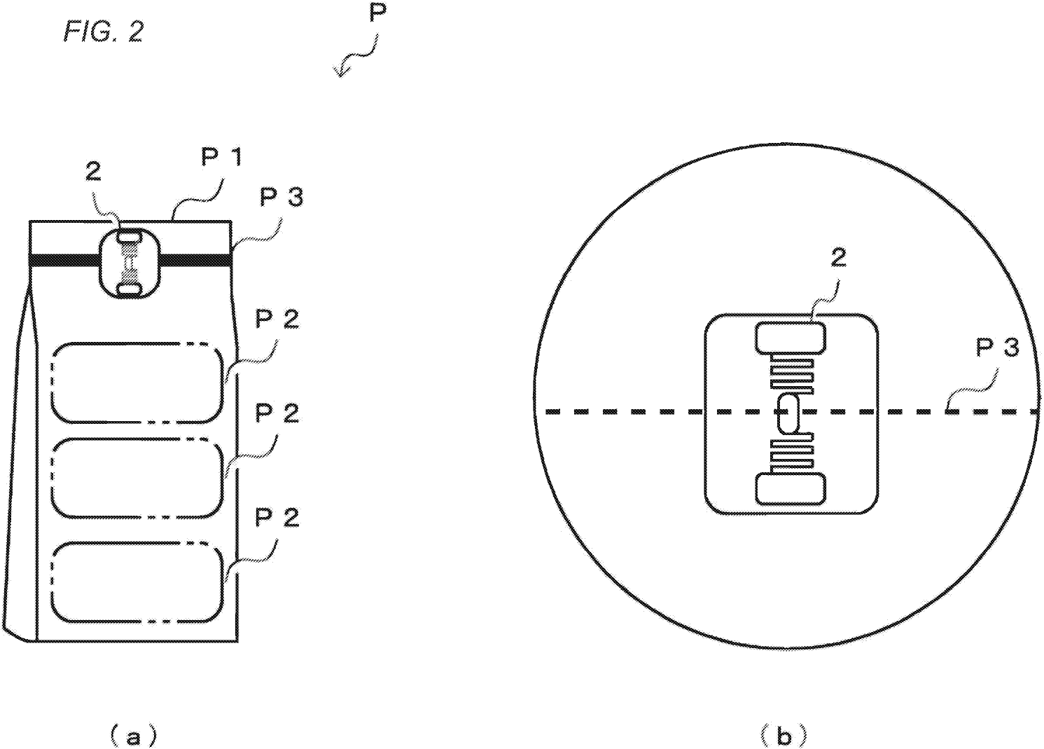

FIG. 2(a) illustrates an example of the product P to which the electronic tag 2 is attached. In the present embodiment, the product P to be subjected to inventory management includes one or more minimum units P2 of the product inside a package P1 and is provided to the user. The package P1 includes a product consumed by the user per one time. The minimum unit P2 of the product is arbitrarily set by a service provider providing the inventory management system 1, for example, in a case where rice is provided as a product, 1 gou or 100 grams is packaged. The product P is provided to the user as the package P1 including the one or more minimum units P2 of the product.

The package P1 is preferably configured to include an opening portion P3. FIG. 2(b) illustrates an enlarged diagram of the electronic tag 2 attached to the opening portion P3. The opening portion P3 is formed with a perforated line or the like so that the user can easily open. In the present embodiment, the shape of the electronic tag 2 is not particularly limited, and an arbitrary shape may be selected from among a card shape, a box shape, a cylindrical shape, a disk shape, a stick shape, a label shape, and the like, but a label shape is preferable from the viewpoint of simplicity of provision to the product P. For example, the electronic tag 2 is attached or printed on one surface of a label such as a seal or a tape, and is attached so as to overlap the opening portion P3. The electronic tag 2 is broken or damaged at the same time as the opening portion P3 is opened. Even if the electronic tag 2 is not completely broken (torn), for example, when a part of the antenna unit 21 is damaged, the electromagnetic wave cannot be reflected. Note that, for example, by forming a perforated line also on the label of the electronic tag 2, it is easy to break the electronic tag 2 by tearing at the same time as the opening the opening portion P3. In addition, the electronic tag 2 is preferably configured to be attached such that the opening direction (perforated line) of the opening portion P3 intersects the long axis of the electronic tag 2. As a result, the electronic tag 2 is invalidated at the same time as the product is consumed, and the measurement apparatus 3 cannot measure the information using the electronic tag 2.

In the present embodiment, the product P is a consumable. There is no particular limitation on the type of consumables as long as the consumables are regularly consumed, such as foodstuffs and daily necessities. For example, the foodstuffs include, but are not limited to, fresh foods such as rice, fruits, meat, and fish, processed foods, beverages, confectionery, seasoning, and the like, and the daily necessities include, but are not limited to, tissues and toilet paper, dry batteries, fluorescent tubes, spray cans and gas cans, stationery, detergents, cosmetics, pharmaceuticals, and quasi-drugs.

In the present embodiment, the package P1 includes those packed in bags such as paper bags or plastic bags, cans, and boxes such as cardboard boxes, paper boxes, or styrofoam boxes. For example, the electronic tag 2 is attached to a portion (opening portion P3) that is a boundary between a lid portion of packaging and a main body portion for storing the product P in packaging using cans or boxes.

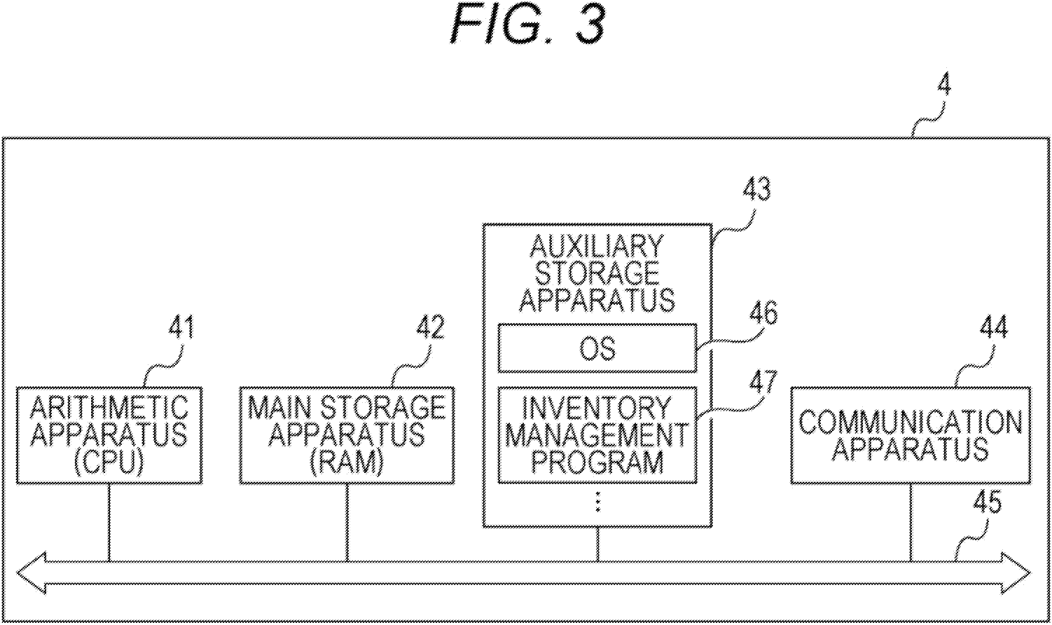

FIG. 3 illustrates is a hardware configuration diagram of the inventory management server 4. The inventory management server 4 includes, as hardware components, an arithmetic apparatus (CPU) 41, a main storage apparatus (RAM) 42 as a working memory, an auxiliary storage apparatus 43 such as an HDD, an SSD, or flash memory, a communication apparatus 44 for communicating with an external apparatus, a bus 45 connecting each configuration unit, and the like. In addition, the auxiliary storage apparatus 43 stores an operating system (OS) 46, an inventory management program 47 that exerts its function in cooperation with the OS 46, various types of information (including data), and the like.

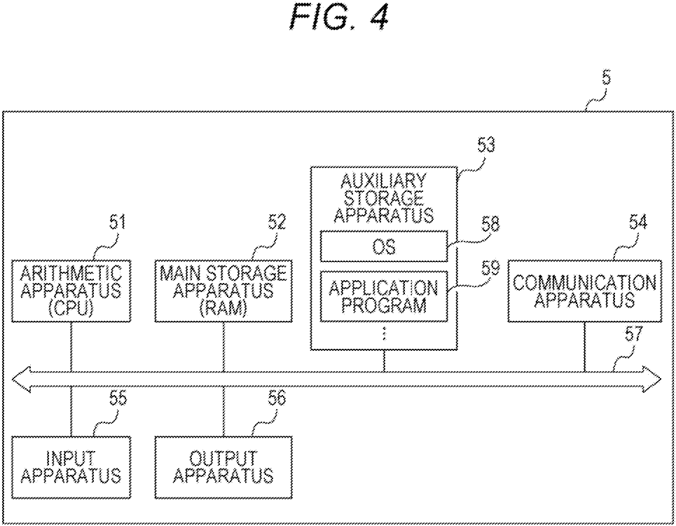

FIG. 4 illustrates is a hardware configuration diagram of the user terminal 5. The user terminal 5 is a terminal apparatus having a communication function, and can use a general computer apparatus including, as hardware components, an arithmetic apparatus (CPU) 51, a main storage apparatus (RAM) 52 as a working memory, an auxiliary storage apparatus 53 such as an HDD, an SSD, or flash memory, a communication apparatus 54 for communicating with an external apparatus, an input apparatus 55 such as a keyboard, a mouse, or a touch panel, an output apparatus 56 such as a display or a speaker, and a bus 57 connecting each configuration unit, and a smartphone, a tablet terminal, a personal computer (PC), or the like can be used as the computer apparatus. In addition, the auxiliary storage apparatus 53 stores an OS 58, an application program 59 that exerts its function in cooperation with the OS 58, various types of information, and the like. In addition, the user terminal 5 includes an input means, a display means, a communication means, and the like as functional components. Note that the communication function also includes communication by near field communication.

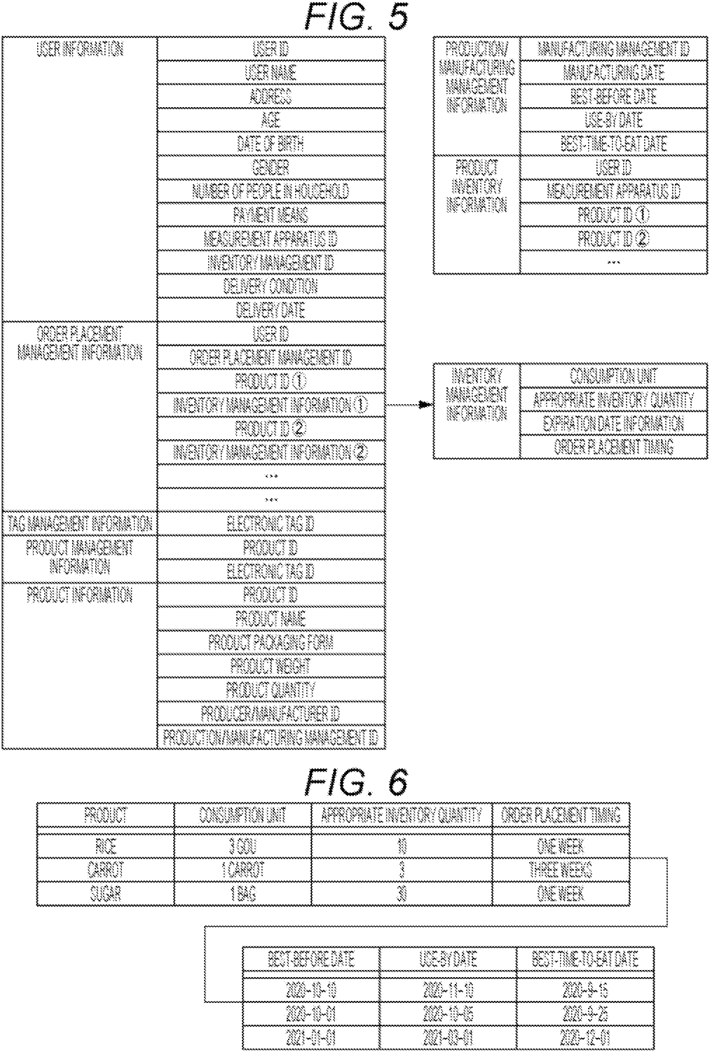

The storage unit DB of the inventory management server 4 stores various types of information for inventory management. The storage unit DB stores user information, order placement management information, tag management information, product management information, product information, manufacturing management information, product inventory information, and the like. FIG. 5 illustrates an example of data stored in the storage unit DB in the present embodiment.

The user information is information regarding the user. The user information is user identification information used to specify the user, and includes a user ID unique to the user, a user name, personal information of the user, a measurement apparatus ID unique to the measurement apparatus 3 installed by the user, an order placement management ID for referring to data (order placement management information) for order placement management of a product, a delivery condition indicating regular delivery or immediate delivery, and a delivery date set in the regular delivery. The personal information of the user includes an address, an age, a date of birth, a gender, the number of people in household, payment means, and the like. The measurement apparatus ID is acquired by the user terminal 5 performing near field communication with the measurement apparatus 3, and is stored in association with the user ID.

The order placement management information is information used for order placement management of each product, and indicates information regarding the product P to be managed by the user. The order placement management information includes a user ID, an order placement management ID, information (product ID) regarding a product stored as stock by the user, and inventory management information for managing the inventory of the product. The product and the inventory management information are set by receiving an input in advance via the user terminal 5.

The tag management information includes a list of electronic tag IDs (tag information). The tag management information includes a product ID and an electronic tag ID corresponding to the product ID.

The product information is information regarding the product. The product information includes a product ID, a product name, a product packaging form indicating a type (bag, can, bottle, or the like) of the package P1, a product weight, a product quantity that is the quantity of minimum units P2 of the product included in the package P1, a producer/manufacturer ID for referring to information regarding a producer or a manufacturer, and a production/manufacturing management ID for referring to information regarding production or manufacturing (manufacturing management information).

The production/manufacturing management information is information regarding production or manufacturing of a product. The manufacturing management information includes a production/manufacturing management ID, a manufacturing date, and expiration date information regarding the expiration date of the product. The expiration date information includes a best-before date, a use-by date, and a best-time-to-eat date. The production/manufacturing management information receives an input via a producer terminal owned by a producer (manufacturer) that has manufactured or produced a product. Note that the best-before date, the use-by date, the best-time-to-eat date, and the like may be changed by reception of an input via the user terminal 5 later.

The product inventory information indicates information regarding a product stored as stock by the user. The product inventory information includes a user ID, a measurement apparatus ID of the measurement apparatus 3 installed by the user, and a product ID of a product specified by tag information measured by the measurement apparatus 3. A plurality of measurement apparatuses IDs may be included, and is identified with the product ID specified by tag information measured by each measurement apparatus ID. Note that the product ID included in the product inventory information and the product ID included in the order placement management information have a correspondence relationship.

The storage unit DB stores information regarding a product included in the product management information as a product inventory table. Here, the product inventory table may combine and store information regarding a plurality of products measured by different measurement apparatuses 3. The information regarding the product included in the product inventory table is stored in association with the inventory management information included in the order placement management information. Note that the information regarding the product may be configured to include a consumption unit in the inventory management information. That is, in the present embodiment, the product ID of the product the consumption unit of which is set to 1 and the product ID of the product the consumption unit of which is set to 2 can be configured to have different product IDs. As a result, the user can collectively designate the product and the consumption unit (quantity) of the product from the tag information and efficiently place an order.

FIG. 6 illustrates an example of a product inventory table associated with inventory management information in the present embodiment. The inventory management information includes the consumption unit of a product set for each user, an appropriate inventory quantity, expiration date information, and an order placement timing. The expiration date information indicates a best-before date, a use-by date, and a best-time-to-eat date specified by referring to the product information. The order placement timing indicates an order placement condition specified by referring to the order placement management information.

The consumption unit corresponds to the quantity of the minimum units P2 of the product included in the package P1. The consumption unit is determined by the user on the basis of the consumption amount of the product per one time or the like, and is set by an arbitrary quantity input via the user terminal 5. In addition, the quantity of the consumption unit may be automatically set by the number of people in household of the user information, and then the quantity may be configured to be changeable via the user terminal 5.

The appropriate inventory quantity indicates an appropriate quantity of inventory of the package P1 of the user, and is set by an arbitrary quantity input via the user terminal 5. Here, the quantity of the minimum units P2 of the product included in the package P1 is determined by the above-described consumption unit. That is, in the product inventory table of “rice”, the amount of rice actually stored as an appropriate inventory is “consumption unit: 3 gou” x “appropriate inventory quantity: 10” = “30 gou”.

In a case where it is determined that the inventory quantity (remaining number) of the products P is less than the appropriate inventory quantity, the order placement timing is data indicating how long after the time point of the determination an order is placed, and is set by an arbitrary period input via the user terminal 5. In a case where the delivery condition of the user information is set to regular delivery and the period of the regular delivery is set to, for example, one week, the order placement timing is set in units of one week. In a case where the order placement timing is not set, one week set as the regular delivery period is applied. Note that, in a case where the delivery condition is set to immediate delivery, the order placement timing is set by an arbitrary number of days or weeks, and in a case where the order placement timing is not set, an order is placed at a time point when it is determined that the inventory quantity of the products P is less than the appropriate inventory quantity.

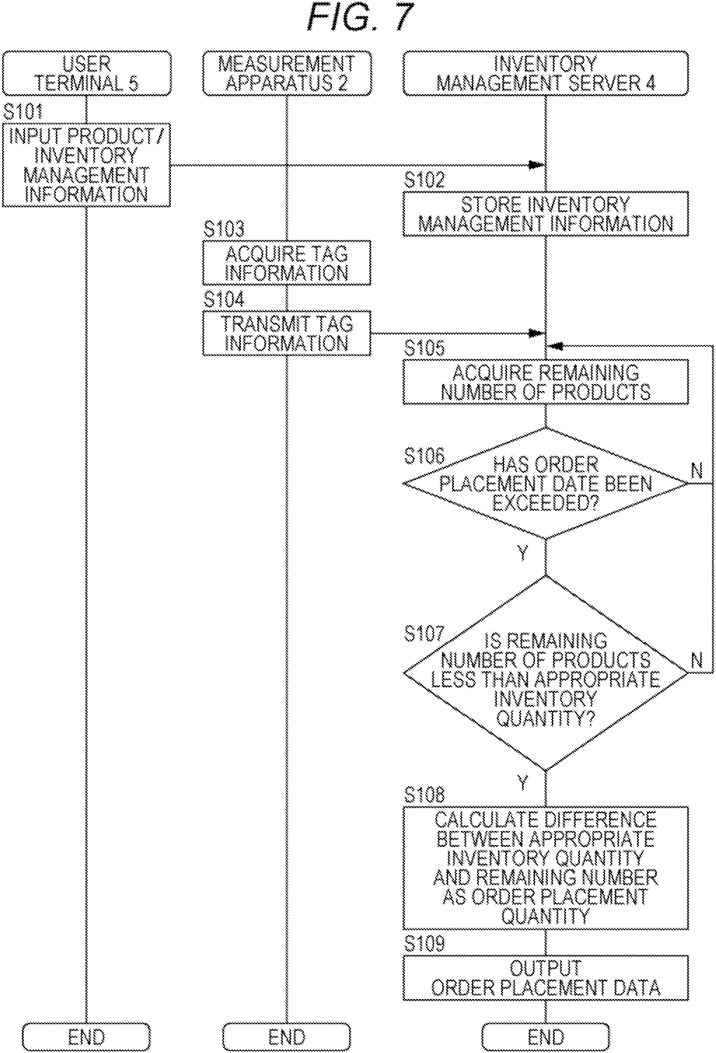

Next, a flow of processing from setting of information regarding inventory management of products by the inventory management system 1 to order placement of the products will be described with reference to a flowchart of FIG. 7.

First, the user registers user information in advance in order to use the inventory management system 1. For example, the registration means 401 receives an input of the user information via a registration screen displayed by activating the application program 59 in the user terminal 5, and stores the user information in the storage unit DB. Note that the registration means 401 may be configured to receive an input of user information via a website accessible by the user terminal 5. The service provider mails the measurement apparatus 3 to the user the user information of which is registered. The measurement apparatus 3 is installed around a space (for example, a shelf or the like) in which the product P to be subjected to the inventory management is stored by the user.

Subsequently, the registration means 401 receives an input of information regarding the product P to be subjected to the inventory management, and stores the information in the storage unit DB. In step S101, the user terminal 5 receives an input of information regarding the product P to be subjected to the inventory management by the user and inventory management information including at least the consumption unit and the appropriate inventory quantity of the product P. The user terminal 5 transmits information regarding the product P to be subjected to the inventory management and transmits the input inventory management information of the product P to the inventory management server 4.

In step S102, the registration means 401 receives the information regarding the product P and the inventory management information regarding the product P from the user terminal 5, and stores the information in the storage unit DB.

In the present embodiment, the product P to be subjected to the inventory management is delivered to the user by mail or the like with the electronic tag 2 attached. Note that the product P to which the electronic tag 2 is attached may be sold in a store or the like and purchased by the user. The product P is placed in the measurement target space of the measurement apparatus 3.

In step S103, the measurement apparatus 3 measures the tag information and the signal strength of the electronic tag 2 located in the measurement target space, and stores the tag information with the signal intensity equal to or higher than a predetermined threshold value in the storage unit 34 as a measurement result. The measurement apparatus 3 determines that the tag information with low or unstable signal intensity is not located in the measurement target space of the measurement apparatus 3 and performs exclusion from the target of the inventory management, so that the electronic tag 2 of the consumed product P can be prevented from being erroneously measured. The measurement apparatus 3 measures the tag information and the signal intensity every certain period (for example, one hour), and updates the measurement result of the storage unit 34 with a new measurement result when a difference occurs between the new measurement result and the previous measurement result stored in the storage unit 34.

The tag information includes the electronic tag ID unique to the electronic tag 2, and even when a plurality of products P having the same product ID is located in the measurement target space, each product P is identified. Note that the tag information may further include information regarding the product.

In step S104, when the measurement result stored in the storage unit 34 is updated, the measurement apparatus 3 associates the tag information included in the measurement result with the measurement apparatus ID of the measurement apparatus, and transmits the tag information to the inventory management server 4. Note that the measurement apparatus 3 may transmit the tag information and the signal intensity in association with the measurement apparatus ID to the inventory management server 4, and the inventory management server 4 may be configured to exclude the product P determined by the corresponding tag information from the inventory management target when the signal intensity is small.

The inventory management server 4 receives the tag information and the measurement apparatus ID from the measurement apparatus 3. The inventory management server 4 refers to the data stored in the storage unit DB and specifies information regarding the user on the basis of the measurement apparatus ID. The inventory management server 4 specifies the product ID on the basis of the received tag information, and stores the specified product ID in association with the product inventory information.

In step S105, the acquisition means 402 acquires the quantity of the products P specified by the tag information as the remaining number of the products P, and stores the quantity in the storage unit DB as remaining number information. The remaining number information may be stored in association with the product inventory table. The acquisition means 402 newly acquires the remaining number of the products P to update and store the remaining number information.

The acquisition means 402 stores the time when the remaining number of the products P specified by the tag information is acquired in association with the tag information, and does not include the product P specified by the corresponding tag information as the remaining number when a predetermined period has elapsed from the time. The predetermined period is set at least to a period equal to or longer than the use-by date of the product P specified by the tag information. As a result, the electronic tag 2 is invalidated when the predetermined period elapses, and for example, it is possible to prevent the electronic tag 2 attached to the consumed product P from being erroneously measured as the remaining number.

The acquisition means 402 does not include the product P determined to have exceeded a predetermined time limit on the basis of the expiration date information of the product P in the remaining number. The predetermined time limit is either a best-before date or a use-by date, and is set via the user terminal 5. Note that the product P determined to have exceeded the use-by date may be configured to be able to be set to be included in the remaining number. In addition, the alert means 404 outputs, to the user terminal 5, an alert for notifying that the expiration date is exceeded regarding the information regarding the product P determined to have exceeded the best-before date or the use-by date.

The user terminal 5 transmits a data acquisition request to the inventory management server 4 to acquire the remaining number information of the products P and the product inventory table, and displays the remaining number information and the product inventory table on the output apparatus 56. In addition, the user terminal 5 may store the acquired latest data in the auxiliary storage apparatus 53.

In step S106, the inventory management server 4 determines whether the current time has exceeded the order placement date. The delivery date is a delivery date set when the delivery condition is regular order placement or is determined by the order placement timing set for each product. Note that, in a case where the delivery condition is order placement on an as-needed basis, it is determined that the order placement date has been exceeded. The inventory management server 4 repeats the processing from step S105 until it is determined that the current time has exceeded the order placement date (N in step S106).

When the inventory management server 4 determines that the current time has exceeded the order placement date (Y in step S106), in subsequent step S107, the order placement means 403 refers to the inventory management information and determines whether or not the remaining number of products acquired in step S105 is less than the appropriate inventory quantity. When it is determined that the remaining number of products is not less than the appropriate inventory quantity (N in step S107), the order placement means 403 does not output order placement data and repeats, for example, the processing from step S105.

When determining that the remaining number of the product is less than the appropriate inventory quantity (Y in step S107), the order placement means 403 calculates a difference between the appropriate inventory quantity of the product P and the remaining number as the order placement quantity of the product P in subsequent step S108. Note that the order placement means 403 may be configured to receive an input of an arbitrary order placement quantity that is equal to or more than the appropriate inventory quantity of the product P via the user terminal 5 and store the order placement quantity in the storage unit DB.

In step S109, the order placement means 403 outputs the order placement data on the basis of the order placement quantity of the product P. The order placement data includes the product P to be ordered, the order placement quantity of the product P, the address of the user, which is the delivery destination, and the like. The order placement means 403 completes the order placement by transmitting the order placement data to an order reception server that receives the order placement of the product P. The order placement data for which order placement has been completed is provided with an order placement flag. Note that the inventory management server 4 may be configured to also function as an order reception server and receive an order placement of the product P.

In a case where it is determined that the product P specified by the tag information measured by the measurement apparatus 3 has a best-time-to-eat period as the expiration date information and has reached the best-time-to-eat period, the alert means 404 outputs an alert notifying that the product P (foodstuff) is best time to eat. Note that the measurement apparatus 3 may be configured include a temperature sensor, and may recalculate and update the best-time-to-eat period included in the expiration date information on the basis of the temperature detected by the temperature sensor and the period from the time when the tag information of the product P is first measured by the measurement apparatus 3 to the current time.

In the present embodiment, the user terminal 5 transmits a recipe information output request to the inventory management server 4. In response to the recipe information output request, the proposal means 405 outputs recipe information of a dish to the user terminal 5 on the basis of the remaining number information of foodstuffs included in the products P in the inventory management information of the user. The user terminal 5 displays the recipe information on the output apparatus 56.

The proposal means 405 specifies all the foodstuffs the remaining number of which is one or more on the basis of the remaining number information of the foodstuffs. Further, the proposal means 405 acquires recipe information of a dish including at least foodstuffs the best-before date or the use-by date of which is the closest on the basis of the expiration date information of the specified foodstuffs, and outputs the recipe information to the user terminal 5. The user terminal 5 displays the recipe information on the output apparatus 56 on the basis of the recipe information output by the proposal means 405. Note that the user terminal 5 may have the function of the proposal means 405, and for example, the user terminal 5 refers to the product inventory table stored in the auxiliary storage apparatus 53, acquires the recipe information of a dish including the foodstuffs the best-before date or the use-by date of which is the closest on the basis of the remaining number information and the expiration date information of the foodstuffs, and displays the recipe information on the output apparatus 56.

In the present embodiment, the recipe information is acquired from an external server connected via the communication network NW. Note that the recipe information may be stored in the inventory management server 4 or the user terminal 5.

In addition, the proposal means 405 outputs the recipe information of a dish including at least foodstuffs on the basis of health information indicating the health state of the user and the foodstuffs included in the remaining number information. The health information includes vital data such as a heart rate, a blood pressure, a respiratory rate, and a body temperature, test data obtained by a health examination, a blood test, a genetic test, and the like, and is stored in the storage unit DB in association with the user information. For example, in a case where the blood pressure higher than the reference value is stored in the health information, the proposal means 405 outputs recipe information including foodstuffs with less salt or foodstuffs containing a large amount of potassium. Here, the recipe information may be acquired on the basis of data indicating a correspondence relationship between the health information and the foodstuffs stored in the inventory management server 4 or the user terminal 5, or may be acquired by search using a combination of the health information and the foodstuffs.

For example, in a case where the user terminal 5 is a smartphone terminal, the vital data is acquired by an installed healthcare-related application or the like. The vital data may be measured by a wearable terminal cooperating with the user terminal 5 and acquired by the user terminal 5. The user terminal 5 transmits the acquired vital data together with the recipe information output request to the inventory management server 4.

The test data is acquired, for example, by receiving an input of a test item from the user terminal 5. The input of the test item may be directly input with a numerical value or the like, or may be captured by optical character recognition (OCR). In addition, the test data is recorded in an external system as electronic medical record information or personal health record information, and the user terminal 5 or the inventory management server 4 may acquire those for which access is permitted or may acquire the test data in cooperation with other healthcare-related applications.

The acquisition means 402 acquires health information including vital data and test data via the user terminal 5 or the wearable terminal.

In addition, the proposal means 405 outputs information regarding insufficient foodstuffs (foodstuffs, shortage, or the like) in at least one of a case where the remaining number of foodstuffs included in the inventory management information is smaller than the necessary number of foodstuffs included in the recipe information and a case where foodstuffs not registered in the inventory management information are included in the foodstuffs of the recipe information.

Reference Signs List

| | |
|---|---|
| 1 | Inventory management system |
| 2 | Electronic tag |
| 3 | Measurement apparatus |
| 4 | Inventory management server |
| 5 | User terminal |
| P | Product |
| NW | Communication network |
| 21 | Antenna unit |
| 22 | IC chip |
| 31 | Antenna unit |
| 32 | Communication processing unit |
| 33 | Control unit |
| 34 | Storage unit |
| 41 | Arithmetic apparatus (CPU) |
| 42 | Main storage apparatus (RAM) |
| 43 | Auxiliary storage apparatus |
| 44 | Communication apparatus |
| 45 | Bus |
| 46 | Operating system |
| 47 | Inventory management program |
| 401 | Registration means |
| 402 | Acquisition means |
| 403 | Order placement means |
| 404 | Alert means |
| 405 | Proposal means |
| DB | Storage unit |
| 51 | Arithmetic apparatus (CPU) |
| 52 | Main storage apparatus (RAM) |
| 53 | Auxiliary storage apparatus |
| 54 | Communication apparatus |
| 55 | Input apparatus |
| 56 | Output apparatus |
| 57 | Bus |
| 58 | Operating system |
| 59 | Application program |
| P1 | Package |
| P2 | Minimum unit of product |
| P3 | Opening portion |

1. An inventory management system comprising:
an electronic tag that stores tag information for specifying a product and is attached to a package of the product; a measurement apparatus that is installed within a measurement range of the electronic tag and measures the tag information; a user terminal; and a server apparatus, wherein
the user terminal
receives an input of a type of a product to be subjected to inventory management, a consumption unit of the product set by an arbitrary quantity as a consumption amount of the product per one time, and an appropriate inventory quantity set on a basis of the consumption unit as inventory management information regarding the product, and transmits the inventory management information to the server apparatus,
the server apparatus includes:
a registration means that stores a type of the product, a consumption unit set by a quantity of one or more of the products, and an appropriate inventory quantity set on a basis of the consumption unit in a storage unit as inventory management information regarding the product on a basis of the inventory management information transmitted from the user terminal,
an acquisition means that acquires a remaining number of the products specified by the tag information measured by the measurement apparatus, and
an order placement means that refers to the inventory management information and outputs order placement data of the product when it is determined that the remaining number of the product is less than the appropriate inventory quantity,
the quantity set as the consumption unit is a quantity of minimum units of the product provided to the user, and
the package includes the quantity of the products set as the consumption unit, and is provided to the user.

2. The inventory management system according to claim 1, wherein
the storage unit stores a number of people in household input via the user terminal,
the consumption unit is set on a basis of the number of people in household, and
the registration means stores the consumption unit set on a basis of the number of people in household in a storage unit as the inventory management information.

3. The inventory management system according to claim 1, wherein
the storage unit
stores measurement apparatus identification information for identifying the measurement apparatus in association with user identification information for identifying a user,
stores the tag information measured by the measurement apparatus having the measurement apparatus identification information in association with the measurement apparatus identification information,
includes a product inventory table including information regarding the product specified by the tag information, and
stores the inventory management information in association with each piece of information regarding the product included in the product inventory table, and
the order placement means outputs order placement data of the product on a basis of the consumption unit included in the inventory management information and a difference between the appropriate inventory quantity and the remaining number of the product.

4. The inventory management system according to claim 3, wherein
the information regarding the product includes the consumption unit, and
the registration means associates the appropriate inventory quantity with the information regarding the product, and stores the information in the storage unit as the inventory management information.

5. The inventory management system according to claim 4, wherein the electronic tag is attached to an opening portion of the package, and is broken or damaged when the opening portion is opened.

6. The inventory management system according to claim 1, wherein the acquisition means stores time when the tag information measured by the measurement apparatus is acquired, and does not include the corresponding tag information in the remaining number of the product when a predetermined period has elapsed from the time.

7. The inventory management system according to claim 1, wherein
the registration means stores, in the storage unit, information regarding the product specified by the tag information in association with expiration date information including a use-by date of the product, and
the acquisition means does not include a product determined to have exceeded a predetermined time limit on a basis of the expiration date information as the remaining number of the product, and
the order placement means outputs the order placement data with a difference between the appropriate inventory quantity of the product and a remaining amount of the product at a predetermined date and time as an order placement quantity.

8. The inventory management system according to claim 1, wherein
in a case where the product is a foodstuff, the registration means stores the information regarding the product specified by the tag information in the storage unit in association with a best-time-to-eat period of the foodstuff, and
the inventory management system comprises: an alert means that outputs an alert notifying that the foodstuff is best time to eat when the best-time-to-eat period is reached.

9. The inventory management system according to claim 8, wherein
the acquisition means acquires health information indicating a health state of the user, and
the inventory management system comprises: a proposal means that outputs recipe information of a dish including the foodstuff on a basis of the health information and the foodstuff included in the inventory management information.

10. The inventory management system according to claim 9, wherein the proposal means outputs information regarding an insufficient foodstuff in at least one of a case where the remaining number of the foodstuff included in the inventory management information is smaller than a necessary number of foodstuffs included in the recipe information and a case where a foodstuff not registered in the inventory management information is included in the foodstuffs of the recipe information.

11. The inventory management system according to claim 1, wherein
the registration means further stores an order placement timing of the product specified by the tag information in the storage unit as the inventory management information, and
the order placement means outputs the order placement data on a basis of the order placement timing.

12. An inventory management method for managing an inventory of a product, the inventory management method executing:
by a measurement apparatus installed in a measurement range, a step of measuring tag information for specifying the product, the tag information being stored in an electronic tag attached to a package of the product;
by a user terminal, a step of receiving an input of a type of a product to be subjected to inventory management, a consumption unit of the product set by an arbitrary quantity as a consumption amount of the product per one time, and an appropriate inventory quantity set on a basis of the consumption unit as inventory management information regarding the product, and transmitting the inventory management information to a server apparatus;
by the server apparatus, a registration step of storing a consumption unit set by a quantity of one or more of the products, and an appropriate inventory quantity set on a basis of the consumption unit in a storage unit as inventory management information regarding the product;
an acquisition step of acquiring a remaining number of the products specified by the tag information measured by the measurement apparatus; and
an order placement step of referring to the inventory management information and outputting order placement data of the product when it is determined that the remaining number of the product is less than the appropriate inventory quantity, wherein
the quantity set as the consumption unit is a quantity of minimum units of the product provided to the user, and
the package includes the quantity of the products set as the consumption unit, and is provided to the user.

13. An inventory management program for managing an inventory of a product using:
a measurement apparatus that is installed in a measurement range and measures tag information for specifying the product, the tag information being stored in an electronic tag attached to a package of the product, and
a user terminal that receives an input of a type of a product to be subjected to inventory management, a consumption unit of the product set by an arbitrary quantity as a consumption amount of the product per one time, and an appropriate inventory quantity set on a basis of the consumption unit as inventory management information regarding the product, and transmits the inventory management information to a server apparatus,
the inventory management program causing the server apparatus to function as:
a registration means that stores a type of the product, a consumption unit set by a quantity of one or more of the products, and an appropriate inventory quantity set on a basis of the consumption unit in a storage unit as inventory management information regarding the product on a basis of the inventory management information transmitted from the user terminal,
an acquisition means that acquires a remaining number of the products specified by the tag information measured by the measurement apparatus, and
an order placement means that refers to the inventory management information and outputs order placement data of the product when it is determined that the remaining number of the product is less than the appropriate inventory quantity, wherein
the quantity set as the consumption unit is a quantity of minimum units of the product provided to the user, and
the package includes the quantity of the products set as the consumption unit, and is provided to the user.
